(19) United States
(12) Patent Application Publication
(10) Pub. No.: US 2009/0032472 A1
(43) Pub. Date: Feb. 5, 2009

(54) Systems and methods for removal of heavy metal contaminants from fluids

(75) Inventors: John A. Krogue, Mineral Wells, TX (US); Timothy L. Holmes, Kingwood, TX (US); Michelle Hewitt, Weatherford, TX (US)

Correspondence Address: GREENBERG TRAURIG, LLP, ONE INTERNATIONAL PLACE, 20th FL, ATTN: PATENT ADMINISTRATOR, BOSTON, MA, 02110, US

(73) Assignee: Perry Equipment Corporation

(21) Appl. No.: 11/888,301

(22) Filed: Jul. 31, 2007

(51) Int. Cl. B01D 15/04; C02F 1/42

(52) U.S. Cl. 210/669; 210/266; 210/688

(57) ABSTRACT

A system for use in the removal of heavy metal contaminants from fluid is provided. The system includes a source from which contaminated fluid may be introduced into the system, a first station for removal by physical separation of a targeted heavy metal contaminant from the flow of fluid, including elemental species of the targeted heavy metal contaminant, and a second station positioned downstream of the first station and in fluid communication therewith for adsorptive separation of the targeted heavy metal contaminant from the fluid flow, including additional amount of the elemental species along with the other species of the targeted heavy metal contaminant. A method for removing heavy metal contaminants from fluid is also provided.

### TECHNICAL FIELD

The present invention relates to systems and methods for treatment of contaminated fluids, and more particularly, to the removal of heavy metal contaminants from fluids.

### BACKGROUND ART

Produced fluid, such as water, from offshore oil platforms can contain toxic heavy metals, for instance, mercury. In the Gulf of Mexico, mercury levels rarely exceed 100 parts per billion (ppb). However, in the Gulf of Thailand, the average concentration of mercury in produced water can range from about 200 ppb to about 2,000 ppb.

Discharge of mercury into the marine environment in U.S. territorial waters is currently regulated by the U.S. Environmental Protection Agency (EPA) under the Clean Water Act via the National Pollutant Discharge Elimination System permit process. According to environmental standards under 40 CFR § 131.36 for marine environment, limits include about 1800 ppb for acute exposure and about 25 ppb for chronic exposure. International standards for mercury discharges in produced water, on the other hand, range from about 5 ppb in Thailand to about 300 ppb in the North Sea.

Produced water often contains oil that was removed with the water during the bulk oil/water separation process. As an example, the produced water from the North Sea fields contains about 15-30 parts per million (ppm) dispersed oil with benzene, toluene, ethylbenzene, and xylene (BTEX); naphthalene, phenanthrene, dibenzothiophene (NPD), polycyclic aromatic hydrocarbon (PAH), phenol, and organic acid concentrations ranging from about 0.06 ppm to about 760 ppm. Additionally, these produced waters contain toxic heavy metals, such as mercury, cadmium, lead, and copper in concentrations ranging from less than about 0.1 ppb to about 82 ppb. The presence of a complex mix of constituents coupled with a high concentration of dissolved salts can present a challenge for heavy metal removal using currently available conventional technologies.

In particular, existing technologies for metal and mercury removal from diluted wastewater include activated carbon adsorption, sulfur-impregnated activated carbon, microemulsion liquid membranes, ion exchange, and colloid precipitate flotation. These technologies may not be suitable for water treatment because of poor metal loading (e.g., metal uptake less than 20% of the mass of the adsorber material) and selectivity, (interference from other abundant ions in groundwater). In addition, mercury may be present in species other than elemental. So the method must be able to remove these other species, such as methyl mercury etc. Furthermore, they lack stability for metal-laden products so that they are not disposable directly as a permanent waste form. As a result, secondary treatment is required to dispose or stabilize the separated mercury or the mercury-laden products. Mercury removal from non-aqueous sludge, adsorbed liquids, or partially- or fully-stabilized sludges, and mercury-contaminated soil is difficult because (1) the non-aqueous nature of some wastes prevents the easy access of leaching agents, (2) some waste streams with large volumes make the thermal desorption process expensive, and (3) the treatment of some waste streams are technically difficult because of the nature of the wastes.

Mercury removal from offgas in vitrifiers and in mercury thermal desorption processes is usually accomplished through active carbon adsorption. However, the carbon-based adsorbents are only effective enough to remove 75 to 99.9% of the mercury with a loading capacity equivalent to 1-20% of the mass of the adsorber material. A last step, mercury amalgamation using expensive gold, usually is needed to achieve the EPA air release standard. A carbon bed usually is used later in the offgas system, where the temperature is generally lower than 250° F. In the sulfur impregnated carbon process, mercury is adsorbed to the carbon, which is much weaker than the covalent bond formed with, for instance, surface functionalized mesoporous material. As a result, the adsorbed mercury needs secondary stabilization because the mercury-laden carbon does not have the desired long-term chemical durability due to the weak bonding between the mercury and active carbon. In addition, a large portion of the pores in the activated carbon are large enough for the entry of microbes to solubilize the adsorbed mercury-sulfur compounds. The mercury loading is limited to about 0.2 g/g of the materials.

The microemulsion liquid membrane technique uses an oleic acid microemulsion liquid membrane containing sulfuric acid as the internal phase to reduce the wastewater mercury concentration from about 460 ppm to about 0.84 ppm. However, it involves multiple steps of extraction, stripping, demulsification, and recovery of mercury by electrolysis and uses large volumes of organic solvents. The liquid membrane swelling has a negative impact on extraction efficiency.

The slow kinetics of the metal-ion exchanger reaction requires long contacting times. This process also generates large volumes of organic secondary wastes. One ion exchange process utilizes Duolite™ GT-73 ion exchange organic resin to reduce the mercury level in wastewater from about 2 ppm to below about 10 ppb. Oxidation of the resin results in substantially reduced resin life and an inability to reduce the mercury level to below the permitted level of less than about 0.1 ppb. The mercury loading is also limited because the high binding capacity of most soils to mercury cations makes the ion-exchange process ineffective, especially when the large amounts of Ca²⁺ from soil saturate the cation capacity of the ion exchanger. In addition, the mercury-laden organic resin does not have the ability to resist microbe attack. Thus, mercury can be released into the environment if it is disposed of as a waste form. In addition to interference from other cations in the solution besides the mercury-containing ions, the ion exchange process is simply not effective in removing neutral mercury compounds, such as HgCl₂, Hg(OH)₂, and organic mercury species, such as methylmercury, which is the most toxic form of mercury. This ion-exchange process is also not effective in removing mercury from non-aqueous solutions and adsorbing liquids.

The reported removal of metal from water by colloid precipitate flotation reduces mercury concentration from about 160 ppb to about 1.6 ppb. This process involves the addition of HCl to adjust the wastewater to pH 1, addition of Na₂S and oleic acid solutions to the wastewater, and removal of colloids from the wastewater. In this process, the treated wastewater is potentially contaminated with the Na₂S, oleic acid, and HCl. The separated mercury needs further treatment to be stabilized as a permanent waste form.

Acidic halide solution leaching and oxidative extractions can also be used in mobilizing mercury in soils. For example KI/I₂ solutions enhance dissolution of mercury by oxidization and complexation. Other oxidative extractants based on hypochlorite solutions have also been used in mobilizing mercury from solid wastes. Nevertheless, no effective treatment technology has been developed for removing the mercury contained in these wastes. Since leaching technologies rely upon a solubilization process wherein the solubilized target (e.g. mercury) reaches a dissolution/precipitation equilibrium between the solution and solid wastes, further dissolution of the contaminants from the solid wastes is prevented once equilibrium is reached. In addition, soils are usually a good target ion absorber that inhibits the transfer of the target ion from soils to solution.

The removal of mercury from nonaqueous liquids, adsorbed liquids, soils, or partially-or-fully-stabilized sludge at prototypic process rates has been lacking. This is mainly because the mercury contaminants in actual wastes are much more complicated than the mercury systems addressed by many laboratory-scale tests that are usually developed based on some simple mercury salts. The actual mercury contaminants in any actual wastes almost always contain multiple species of mercury, including ionic or inorganic mercury (e.g., divalent cation Hg²⁺, monovalent Hg₂²⁺, and neutral compounds such as HgCl₂, Hg[OH]₂,); organic mercury, such as methylmercury (e.g., CH₃ HgCH₃ or CH₃ Hg⁺) as a result of enzymatic reaction in the sludge; and elemental or metallic mercury, because of reduction. Since many laboratory technologies are developed for only one form or species of mercury, demonstrations using actual wastes have not been successful.

Other metals that are of interest for remediation and industrial separations include but are not limited to silver, lead, arsenic, uranium, plutonium, neptunium, americium, cadmium and combinations thereof. Present methods of separation include but are not limited to ion exchangers, precipitation, membrane separations, and combinations thereof. These methods usually have the disadvantages of low efficiencies, complex procedures, and high operation costs.

Accordingly, it would be advantageous to provide a system and method that can be used to remove heavy metal contaminants, such as mercury, cadmium, lead, as well as arsenic from complex waste fluids, such as produced water, in a significant amount and in a cost effective manner.

### SUMMARY OF THE INVENTION

The present invention, in one embodiment, provides to a system for removal of heavy metal contaminants from fluids. The system, in an embodiment, includes a source from which a flow of fluid containing various species or form of heavy metal contaminants, including elemental species, organic form, and ionic form may be introduced into the system. The system also includes a first station for physical separation or removal of the elemental species of a targeted heavy metal contaminant from the fluid flow. In an embodiment, the first station may include a liquid/liquid phase coalescer having a coalescing element designed to coalesce or merge small diameter droplets containing the elemental species of the targeted heavy metal contaminant into larger droplets, which droplets can thereafter be separated by gravity from the fluid flow. The system also includes a second station downstream of the first station and in fluid communication therewith for adsorptive separation or removal of the remainder of the elemental species along with the other species of the predetermined heavy metal contaminant from the fluid flow. The second station, in an embodiment, includes a reactor having an adsorbent nanomaterial made from a porous particle. The porous particle, for instance, can be self-assembled monolayer on mesoporous supports (SAMMS). In one embodiment, the system can include a prefilter station upstream of the first station to remove solid contaminants from the fluid flow, so as to prolong the life of the coalescer in the first station. The system can further include, in another embodiment, a third station downstream of the second station and in fluid communication therewith for separation or removal of another predetermined contaminant different from that removed by the second station. This third station may be designed to also contain an adsorbent nanomaterial including a porous particle made from self-assembled monolayers on mesoporous supports (SAMMS).

The present invention, in another embodiment, provides a system for removal of heavy metal contaminants from fluids. The system, in an embodiment, includes a source from which a flow of fluid containing various species or form of heavy metal contaminants, including elemental species, organic form, and ionic form may be introduced into the system. The system also includes a first station for physical separation or removal of the elemental species of a targeted heavy metal contaminant from the fluid flow. In an embodiment, the first station may include a liquid/liquid phase coalescer having a coalescing element designed to coalesce or merge small diameter droplets containing the elemental species of the targeted heavy metal contaminant into larger droplets, which droplets can thereafter be separated by gravity from the fluid flow. The system also includes a second station downstream of the first station and in fluid communication therewith for adsorptive separation or removal of the remainder of the elemental species along with the other species of the predetermined heavy metal contaminant from the fluid flow. The second station, in an embodiment, includes a vessel along with a filter apparatus having an adsorbent nanomaterial made from a porous particle. The porous particle, for instance, can be made from self-assembled monolayers on mesoporous supports (SAMMS). In one embodiment, the system can include a prefilter station upstream of the first station to remove solid contaminants from the fluid flow, so as to prolong the life of the coalescer in the first station. The system can further include, in another embodiment, a third station downstream of the second station and in fluid communication therewith for separation or removal of another predetermined contaminant different from that removed by the second station. This third station may be designed to contain a filter apparatus having an adsorbent nanomaterial including a porous particle made from self-assembled monolayers on mesoporous supports (SAMMS).

The present invention, in a further embodiment, provides a method for removal of heavy metal contaminants from fluid. The method includes initially introducing, into a pathway, a flow of fluid containing heavy metal contaminants to be removed, including various species of targeted heavy metal contaminants. Next, the fluid flow may be subject to a physical separation protocol for removing a targeted heavy metal contaminant from the fluid, including elemental species of the targeted heavy metal contaminant, so as to reduce the overall concentration of the targeted heavy metal contaminant from the fluid flow. Thereafter, the fluid flow having a reduced overall concentration of the targeted heavy metal contaminant may be exposed to an adsorptive separation protocol for removing additional amount of the targeted heavy metal contaminant from the fluid, including additional amount of the elemental species along with the other species of the targeted heavy metal contaminant, so as to further reduce the concentration of the targeted heavy metal contaminant to an acceptable level. The method may include, prior to the physical separation, a prefilter treatment to remove solid contaminants from the fluid flow. The method may further include, subsequent to the adsorptive separation, another adsorptive separation to remove either a targeted heavy metal contaminant different from that targeted in the initial adsorptive separation, or a targeted heavy metal contaminant similar to that targeted in the initial adsorptive separation.

### BRIEF DESCRIPTION OF DRAWINGS

FIG. 1 illustrates a system having a first station and a second station designed for removal of heavy metal contaminants from fluids in accordance with one embodiment of the present invention.

FIG. 2 illustrates a liquid/liquid coalescer for use in connection with the first station of the system shown in FIG. 1.

FIG. 3 illustrates a reactor for use in connection with the second station of the system shown in FIG. 1.

FIG. 4A illustrates a prefilter station for use in connection with the system shown in FIG. 1.

FIG. 4B illustrates a reactor and filter element for use at the prefilter station shown in FIG. 4A.

FIG. 5 illustrates a third station for use in connection with the system shown in FIG. 1 to permit removal of a contaminant different from that removed by the first and second stations.

FIG. 6 illustrates another system having a first and second station for use in the removal of heavy metal contaminants from fluids in accordance with the present invention.

FIG. 7 illustrates a vessel for use at the second station of the system shown in FIG. 6.

FIG. 8 illustrates a filter element for use in connection with the vessel shown in FIG. 7.

FIG. 9 illustrates a prefilter station for use in connection with the system shown in FIG. 6.

FIG. 10 illustrates a third station for use in connection with the system shown in FIG. 6 to permit removal of a contaminant different from that removed by the first and second stations.

FIG. 11 illustrates yet another system for use in the removal of heavy metal contaminants from fluids in accordance with the present invention.

### DESCRIPTION OF SPECIFIC EMBODIMENTS

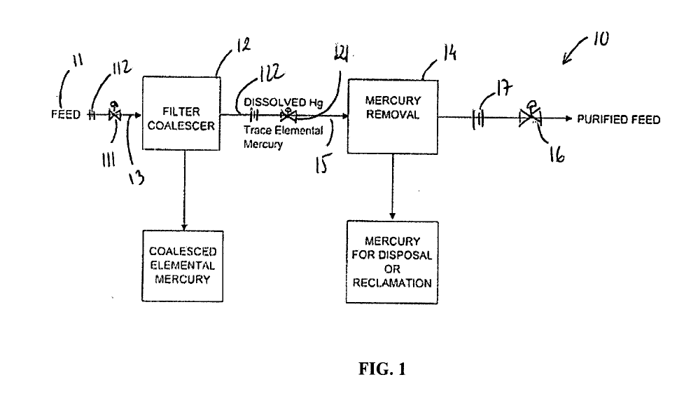

With reference to FIG. 1, the present invention provides, in one embodiment, a system 10 for treating contaminated fluid by removing contaminants that exist within the fluid. Fluids which may be treated in connection with the present invention may be viscous in nature, such as oil, or non-viscous in nature, such as a liquid or a gas. Contaminants that may be removed by system 10 of the present invention include heavy metals, such as mercury, arsenic, cadmium, and lead from complex waste fluids, such as produced water, and mercury from a variety of waste solutions and contaminated waste oils. Other contaminants that may be removed by system 10 of the present invention includes silver, uranium, plutonium, neptunium, americium, or a combination thereof.

The system 10, as illustrated in FIG. 1, includes, in an embodiment, a source 11 from which a flow of contaminated fluid may be introduced into the system. The contaminated fluid may contain various species or forms of heavy metal contaminants, including their elemental form, organic form, and ionic form. In accordance with one embodiment, the contaminated fluid may be a waste fluid, such as produced water generated in connection with oil or gas drilling and may contain various species of, for instance, mercury. Examples of the different species of mercury include ionic or inorganic mercury (e.g., divalent cation Hg²⁺, monovalent Hg₂²⁺, and neutral compounds such as HgCl₂, Hg[OH]₂,); organic mercury, such as methylmercury (e.g., CH₃ HgCH₃ or CH₃ Hg⁺) as a result of enzymatic reaction in the sludge; and elemental or metallic mercury.

The contaminated fluid, as shown in FIG. 1, may be introduced into system 10 at a controlled rate. To control the flow rate of the fluid, a flow control valve 111 may be provided downstream of source 11. In addition, a flow-meter 112 may be provided between the source 11 and the control valve 111 to help in determining the flow rate, and if necessary, to permit adjustment of the control valve 111 to an appropriate level. It should be noted that although system 10 is shown having a control valve 111, such a valve may not be necessary should the flow rate be capable of being adjusted from the source 11 based on the reading on the flow-meter 112.

The system 10 may also include a first station 12 designed to implement a physical separation protocol for removal of, for instance, elemental species of a targeted heavy metal contaminant, such as mercury, from the fluid flow. In an embodiment, first station 12 may be in fluid communication with source 11 via pathway 13, for example, a pipe, a hose, or any similar conduit capable of conducting fluid flow from source 11 to first station 12.

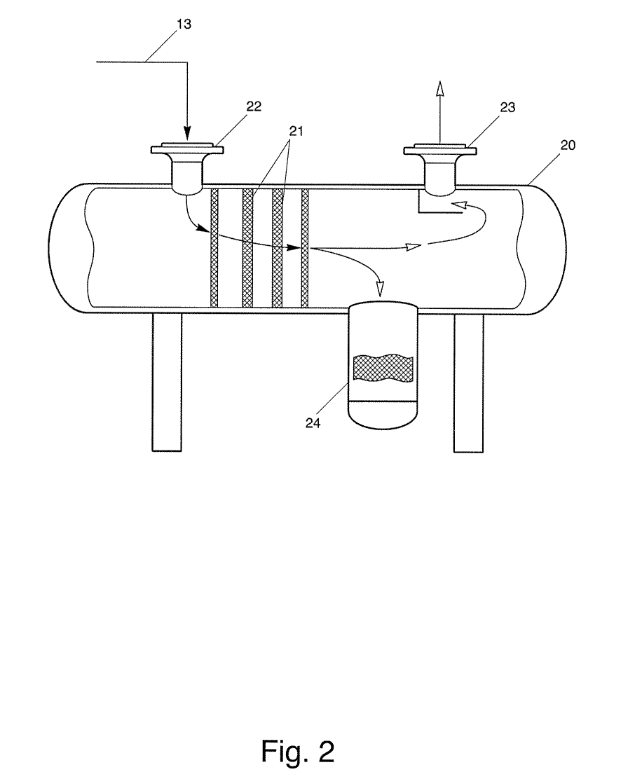

Looking now at FIG. 2, the first station 12, in one embodiment, may include a coalescing unit 20 having at least one coalescing element 21 designed to coalesce or merge small diameter droplets containing elemental species of the heavy metal contaminant into larger droplets for subsequent removal. An example of a coalescing unit 20 includes a liquid/liquid coalescer, such as the Series 110H or Series 110V available from Perry Equipment Corporation in Mineral Wells, Tex. An example of a coalescing element 21 may be a PEACH® LiquiSep element, also available from Perry Equipment Corporation in Mineral Wells, Tex.

The coalescing unit 20, in an embodiment, may include inlet 22 through which a continuous flow of contaminated fluid from source 11 via pathway 13 may be received and outlet 23 through which treated fluid may exit. The coalescing unit 20 may also include a coalescing element 21 designed to permit the flow of contaminated fluid therethrough and to initiate a physical separation process for removal of the elemental species of the heavy metal contaminant from the fluid flow. In one embodiment, the coalescing element 21 may be made from a hydrophilic and oleophilic material, so as to permit the fluid flow to separate into a discontinuous phase (i.e., colloidal flow) and a continuous phase (i.e., the process/fluid flow). Moreover, as the design of the coalescing element 21 permits the element 21 to implement a saturated depth coalescing process, when the discontinuous phase moves through the coalescing element 21, substantially small diameter droplets containing elemental species of the heavy metal in the discontinuous phase may be allowed to coalesce. In particular, the coalescing element 21 permits “like materials” to attract “like materials”, so as to take the substantially small diameter droplets containing the elemental species of the heavy metal in the discontinuous phase and allow these substantially small diameter droplets to merge or combine to form substantially larger diameter droplets. The larger diameter droplets, over time, can form still larger droplets and eventually can become sufficiently large and heavy. It should be noted that due to the density of the heavy metal within these sufficiently large droplets, along with interfacial surface tension, these sufficiently large droplets tend to drain from the coalescing element 21 in the presence of gravity, and settle out from the continuous phase to the bottom of the coalescing unit 20. To collect and subsequently dispose of the drained liquid containing the elemental species of the heavy metal being separated, the coalescing unit 20 may be provided with container 24.

Although illustrated as being vertical, it should be appreciated that the coalescing elements 21 may be designed to be substantially horizontal within the coalescing unit 20. Similarly, although illustrated as being horizontal, the coalescing unit 20 may be designed to be substantially vertical. Moreover, although the use of a coalescing unit is described herein, physical separation for removal of the elemental species of the heavy metal may be carried out by other phase separation devices, for example, vanes, mesh pads, packed beds, centrifuges, other similar devices, or a combination of these.

The system 10, as illustrated in FIG. 1, may further include a second station 14 located downstream of the first station 12 and in fluid communication with outlet 23 of coalescing unit 20. The second station 14, in an embodiment, may be provided for adsorptive separation or removal of the additional amount of the elemental species, along with the other species of the targeted heavy metal contaminant, such as mercury, from the fluid flow.

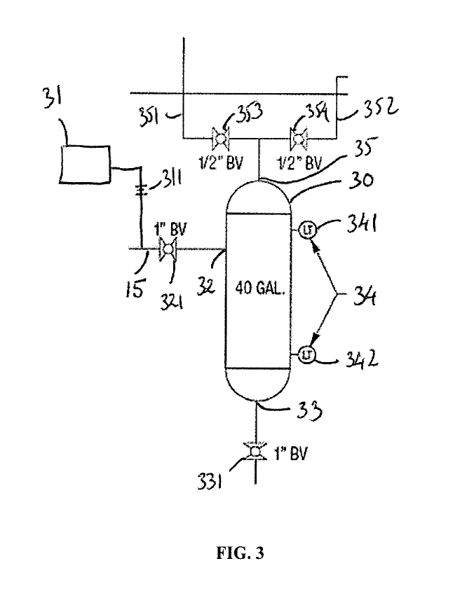

With reference now to FIG. 3, the second station 14, may include a reactor, such as reactor 30, within which a batch of an adsorbent material may be accommodated for further treatment of fluid from the first station 12. In an embodiment, the adsorbent material may be a nanosorbent material (i.e., adsorbent nanomaterial) manufactured from self-assembled monolayers on mesoporous supports (SAMMS). It should be appreciated that reference to the term “adsorbent material” hereinafter includes nanosorbent material or adsorbent nanomaterial, either of which may be used interchangeably with the other. The mesoporous support, in an embodiment, may be made from various porous materials, including silica. The advantage of the SAMMS material is its ability to remove all species of various targeted heavy metals, depending on the particular functional group associated with the SAMMS material. An example of a SAMMS material that can be used in connection with the reactor 30 of the present invention includes thiol-SAMMS (i.e., SAMMS material that have been functionalized with thiol groups) for targeting all species of mercury, similar to that disclosed in U.S. Pat. No. 6,326,326, which patent is hereby incorporated herein by reference. The SAMMS material, of course may be functionalized with other groups, depending on the contaminant targeted for removal from the fluid. For instance, the SAMMS material may be functionalized with lanthanum groups for arsenic removal, or with amine groups for CO₂ removal.

In accordance with one embodiment of the present invention, the adsorbent material may include porous particles, ranging from about 5 microns to about 200 microns in size. In an embodiment, the particles, on average, range from about 50 microns to about 80 microns in size, include a pore size ranging from about 2 nanometers (nm) to about 7 nm, and may be provided with an apparent density ranging from about 0.2 grams/milliliter to about 0.4 grams/milliliter.

Although the adsorbent material is disclosed above as being manufactured from SAMMS, it should be appreciated that other adsorbent materials may be used, so long as these adsorbent materials can act to remove contaminants from the fluid flow. One example of an alternate adsorbent material includes commercially carbon particles ranging from about 8 to about 30 mesh in size.

To permit ease of introduction into the reactor 30, the adsorbent material may be provided as a slurry mixture. In particular, the adsorbent material may be mixed with a liquid, such as water, to provide the necessary slurry mixture. This slurry mixture may, in an embodiment, be maintained in a mixed form within reservoir 31 by methods known in the art, for example, by any mechanical devices or fluid injection mechanisms capable of creating a necessary turbulence. Alternatively, it should be appreciated that as the slurry mixture is introduced into reactor 30 via pathway 15, the natural turbulence of the stream of slurry mixture moving along pathway 15 may be sufficient to generate the appropriate mixing. Should it be necessary or to further enhance mixture of the slurry, a mixer (not shown), such as a static mixer commercially available through many outlets in the industry, may be provided immediately downstream of the reservoir 31. The presence of this static mixer can further optimize the mixing of the slurry as it flow along pathway 15 into reactor 30. Of course, if desired, instead of using a slurry, dried adsorbent material may be provided within the reactor 30.

The adsorbent material, in an embodiment, may be provided within reactor 30 prior to the introduction of the fluid flow from the first station 10. Alternatively, the adsorbent material may be introduced into pathway 15 along with the fluid from the first station 12 and allowed to mix therewith prior to entry into reactor 30. In such an embodiment, the amount of adsorbent material introduced can be critical, since an appropriate amount may need to be determined in order to provide an optimum heavy metal contaminant removal capacity. In particular, the amount of adsorbent material that may be needed can be proportional to the flow rate of the fluid from the first station 12 and the amount of contaminant within that fluid flow. Generally, the amount of contaminant will be constant, so that the flow rate of the fluid may be a parameter which needs to be controlled.

To control the flow rate from first station 12, looking at FIG. 1, a flow control valve 121 may be provided downstream of the first station 12. In addition, a flow-meter 122 may be provided between the first station 12 and the control valve 121 to help in determining the flow rate before control valve 121 is adjusted to an appropriate level. It should be noted that control valve 121 may not be necessary should the flow rate be capable of being adjusted from the first station 12 based on the reading on the flow-meter 122.

To control the introduction of the adsorbent material from reservoir 31 into pathway 15, looking at FIG. 3, so that the amount of adsorbent material can be proportional to the flow rate of the fluid from the first station 12 and the amount of contaminant within that fluid flow, a metering pump 311 may be provided to permit either manual or automatic control of the amount of the adsorbent material being introduced.

In one embodiment, reactor 30 provides an environment within which the fluid from the first station 12 and the adsorbent material from reservoir 31 (“fluid/adsorbent mixture”) may be accommodated over a period of time. During this time period, remaining species of heavy metal contaminants from the fluid may be adsorbed by the adsorbent material and removed from the fluid until an acceptable concentration of heavy metal contaminants within the fluid has been reached. The period of time, in an embodiment, can be determined by the kinetics of the adsorption of the contaminants into the adsorbent material, as well as by the diffusion time of the contaminants within the fluid flow into the adsorbent material, and may last from about less than two minutes to about ten minutes. It should be noted that introduction of the fluid/adsorbent mixture into the reactor 30 can provide sufficient turbulence in order to achieve the necessary mixing action between the contaminated fluid and the adsorbent material. To the extent needed, a mixing mechanism may be provided within the reactor 30.

In accordance with an embodiment of the present invention, reactor 30 may be provided with an inlet 32 and an outlet 33. As shown in FIG. 3, inlet 32 may be controlled by inlet valve 321 and outlet 33 may be controlled by outlet valve 331. Valves 321 and 331, in an embodiment, may be automatically actuated or electronically controlled by means known in the art. Alternatively, these valves may be designed to be manually actuated. Reactor 30 may also include a level transmitter or sensor 34 to indicate when the reactor 30 is full and when it is empty. In the embodiment shown in FIG. 3, the sensor 34 includes a top sensor 341 to determine and indicate when reactor 30 is substantially full, and a bottom sensor 342 to determine and indicate when reactor 30 is substantially empty. Reactor 30 may also include a pump (not shown) to assist in the removal or draining of treated fluid through outlet 33.

In an alternate embodiment, rather than a pump, reactor 30 may include an second inlet 35 coupled to, for instance, two natural gas lines 351 and 352 to assist in the removal of the treated fluid from the reactor 30. In particular, line 351 may be a “gas-in” line that may be regulated by a gas-in valve 353 to a relatively slightly higher pressure than that of an operating pressure of the contaminated fluid. In this manner, the higher pressure can act to subsequently push the treated fluid from the reactor 30. Line 352, on the other hand, may be a “gas-out” line that may be regulated by gas-out valve 354 to maintain a substantially similar pressure to that of the contaminated fluid pressure. Operation of these gas lines in connection with the emptying of treated fluid from the reactor 30 will be discussed hereinafter in detailed. Moreover, although described in connection with natural gas, it should be appreciated other gases may be used.

The system 10, as shown in FIG. 1, may further be provided with discharge valve 16 and flow-meter 17 for use in connection with the discharge of cleaned or treated fluid from system 10. The flow-meter 17, in an embodiment, can help to determine the flow rate of the cleaned or treated fluid while the discharge valve 16 can be used to control the discharge rate relative to the flow rate.

A separation device (not shown) may also be provided in system 10 for the removal of spent adsorbent material. In one embodiment, the separation device may be a centrifuge-type separation device. Such a device, in an embodiment, uses centrifugal force to concentrate spent adsorbent material at the bottom of the device. A collector (not shown) may also be provided, so that the spent adsorbent material concentrated at the bottom of the separation device may be directed thereinto and removed from system 10. Alternatively, the separation device may be a filter designed with pores or mesh openings capable of preventing particles, such as the adsorbent material, ranging from about 5 microns to about 200 microns in size, from moving thereacross. The separation device, in an embodiment, may be located downstream from reactor 30. Alternatively, separation device may be located, for example, about outlet 33 to remove the spent adsorbent nanomaterial as it exits the reactor 30.

In operation, contaminated fluid containing heavy metal contaminants within source 11 may be directed into pathway 13 toward first station 12. The rate of flow of the contaminated fluid from source 11, in an embodiment, may be controlled by control valve 111, to permit an appropriate volume to continuously flow into the first station 12.

Upon reaching the first station 12, the contaminated may be directed into coalescing unit 20 through inlet 22. Once within the coalescing unit 20, the flow of contaminated fluid may be directed through coalescing element 21 to initiate a physical separation process for removal of the elemental species of the heavy metal contaminant. Specifically, as the fluid enters element 21, the fluid flow may be separated into a discontinuous phase and a continuous phase. Thereafter, as the two phases continue to move through element 21, the discontinuous phase may be allowed to coalesce by way of a saturated depth coalescing process. In particular, the coalescing element 21 permits “like materials” to attract “like materials”, so as to take substantially small diameter droplets containing elemental species of the heavy metal in the discontinuous phase and allow these substantially small diameter droplets to merge or combine to form substantially larger diameter droplets. The larger diameter droplets, over time, can form still larger droplets. When they have become sufficiently large, the density of the heavy metal within these sufficiently large droplets, along with interfacial surface tension, tend to cause these droplets to drain from the coalescing element 21 in the presence of gravity and settle out from the continuous phase to the bottom of the coalescing unit 20. The drained liquid containing the elemental species of the heavy metal being separated may thereafter be collected within container 23 of coalescing unit 20 for subsequent disposal.

Fluid from the coalescing unit 20 at the first station 12 may thereafter be directed toward the second station 14 by way of pathway 15. At second station 14, reactor 30 may, in an embodiment, be substantially filled with the adsorbent material. Alternatively, the adsorbent material may be introduced into pathway 15 along with the fluid flow from the first station, so as to form a fluid/adsorbent mixture for introduction into reactor 30 through inlet 32. In the embodiment shown in FIG. 3, as the fluid/adsorbent mixture fills reactor 30 and approaches the location of the top sensor 341, the top sensor 341 may transmit, when reactor 30 is full, a signal to a PLC. Upon receipt of the signal, the PLC can act to thereafter close the inlet valve 321 of reactor 30. It should be noted that during this filling process, the adsorbent material, as mentioned above, can act to remove the heavy metal contaminants from the contaminated fluid to provide substantially clean fluid. In particular, in the presence of the adsorbent material, which in one embodiment, may be mesoporous SAMMS, fluid can be permitted to flow through the pores of the particles in the SAMMS material. Within these pores, targeted heavy metal contaminants, such as all species of mercury, come in contact with a monolayer of chemical designed to attract and bind the molecules of these contaminants, along with the other constituents of the fluid flow. As such, these particular contaminants may be trapped within the SAMMS material and removed from the fluid flow.

The performance efficiency for separation and removal of the targeted heavy metal contaminant in accordance with one embodiment of the present invention can be dependent upon a variety factors, including the fluid being processed, the form or species of the targeted heavy metal contaminant that may be present in the fluid, the presence of other contaminants, among others. As such, the amount removed can vary. For example, since there exist a substantial difference in density between, for instance, mercury and a gas or air (i.e., fluid), low effluent concentrations can be obtained.

Subsequently, the outlet valve 331 may be opened and the clean fluid permitted to exit through outlet 33 and out of the reactor 14. This emptying process may continue until the cleaned liquid level reaches bottom sensor 342, at which time the bottom sensor 342 may transmit a signal to the PLC. Thereafter, the PLC may act to close the outlet valve 331. The reactor 30 may thereafter be ready to go through another filling cycle.

Once the adsorbent material within reactor 30 becomes used up or spent, the reactor 30 may be taken out of service, the adsorbent material removed, and a batch of new adsorbent material put into reactor 30. To determine when the adsorbent material may be used up, several approaches may be implemented. In one approach, it is known that as the adsorbent material becomes filled with contaminants, its differential pressure will increase. This is because heavy metal contaminants in the fluid once trapped by the adsorbent material will tend to plug the porous adsorbent material over time. As such, it will be important to monitor the differential pressure of the adsorbent material.

In another approach, the status of the adsorbent material may be determined by periodically or continuously monitoring the level of contaminants of the treated fluid in the outlet stream. When the level in the outlet stream increases to a certain point, the adsorbent material may be changed.

It should be appreciated that physical separation may not remove substantially all traces of elemental species of the targeted heavy metal contaminant, or lower the concentration of elemental species to a substantially safe or allowable level, for example, parts per billion (ppb) or parts per trillion (ppt) as suggested by the government for certain heavy metals, e.g., mercury. Nevertheless, such a process can significantly lower the concentration of the elemental species, in many instances, well below the parts per million (ppm) level. To this end, by employing physical separation to initially reduce the concentration of elemental species from the discontinuous phase (i.e., colloidal flow), the life as well as the performance of the adsorbent material employed in the subsequent second station 14 can be substantially extended.

For example, if the contaminated fluid from source 11 contains about 1,000 ppb of elemental mercury, about 100 ppb of ionic mercury, and about 100 ppb of organic mercury, the total amount of mercury in the contaminated fluid is about 1,200 ppb. When the fluid is initially treated with a physical separation process for removal of the elemental mercury, the amount of elemental mercury that subsequently remains within the fluid may be about 100 ppb. As such, the fluid directed to the second station 14 would have only about 300 ppb of mercury, as opposed to 1,200 ppb of mercury. This reduction in the concentration of mercury can lengthen the life and performance of the expensive adsorbent material in the second station 14 by four times, and thus also greatly reduce the overall cost of the treatment process.

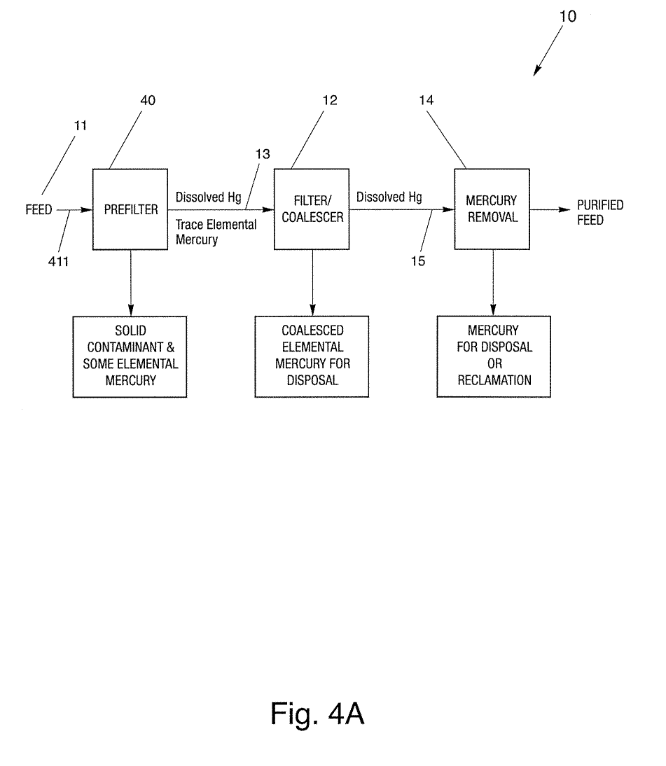

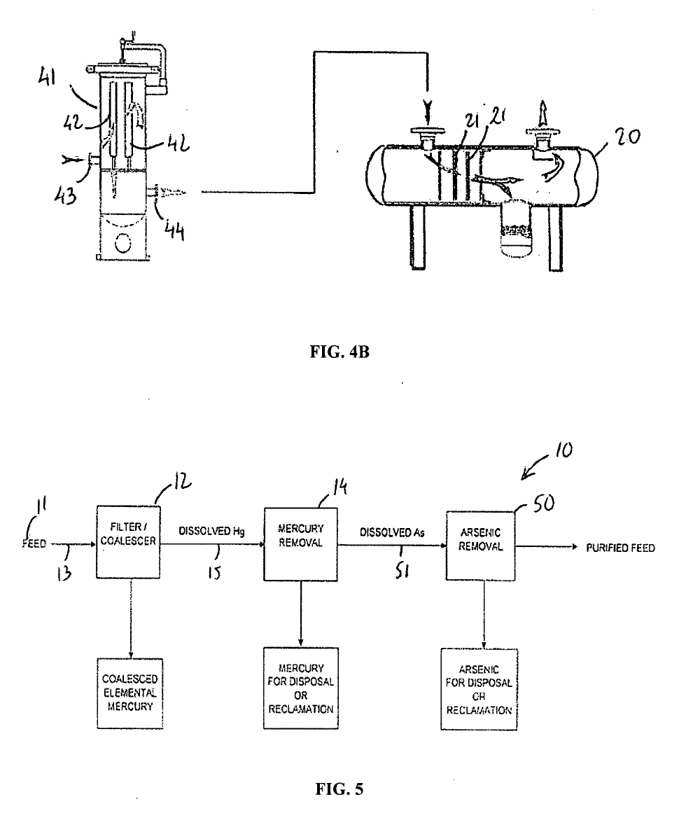

To further reduce the cost of the treatment process, referring now to FIGS. 4A-B, system 10, in accordance with another embodiment of the present invention, may be provided with prefilter station 40 upstream of the first station 12. The utilization of a prefilter station 40 can, among other things, prolong the life, as well as the performance of the more expensive coalescing element 21 within the coalescing unit 20 at station 12.

The prefilter station 40, in one embodiment, may include prefilter reactor 41, as shown in FIG. 4B, having at least one filter element 42 designed to remove solid contaminants. An example of a prefilter reactor 41 may be the Series 55 reactor available from Perry Equipment Corporation in Mineral Wells, Tex. An example of a filter element 42 may be a PEACH® Gold technology element, also available from Perry Equipment Corporation in Mineral Wells, Tex.

The prefilter reactor 41, as illustrated, may include an inlet 43 through which a continuous flow of contaminated fluid from source 11 may be directed into reactor 41 via pathway 411. Reactor 41 may also include outlet 44 through which fluid treated by filter element 42 may exit and gets directed toward the coalescing unit 20 via pathway 13. The filter element 42, in an embodiment, may be designed to permit the flow of contaminated fluid from source 11 to move therethrough, and to separate and remove solid contaminants from the fluid flow. It should be appreciated that to the extent solid contaminants are not removed and may be present in the fluid flow when the fluid flow is directed into the first station 12 from source 11, such solid contaminants can act to block the pores of the coalescing element 21, thereby reducing its performance and life expectancy. Filter element 42, in certain instances, by its design can remove heavy metal contaminants from the fluid flow. In particular, when the contaminated fluid may have a substantially high loading (i.e., high concentration) of heavy metal contaminants, the filter element 42 can be used to separate out and reduce the heavy metal concentration, along with the concentration of solid contaminants, within the fluid flow, before passing the fluid to the coalescing unit 20 and coalescing element 21 at station 12. To that end, the life and performance of the coalescing element 21 can be further prolonged.

Looking now at FIG. 5, there is illustrated another embodiment of system 10 in accordance with one aspect of the present invention. System 10, as shown in FIG. 5, may be provided with a third station 50, downstream of the second station 14, for adsorptive separation and removal of other heavy metal contaminants. In one embodiment of the present invention, the third station 50 may include a reactor (not shown) substantially similar to reactor 30 of second station 14, and within which an adsorbent material may be accommodated for treatment of fluid received from the second station 14 by way of pathway 51. The adsorbent material in the reactor at the third station 50, in one embodiment, may also be a nanosorbent material manufactured from self-assembled monolayers on mesoporous supports (SAMMS), similar to the adsorbent material in reactor 30 of second station 14. However, it should be appreciated that the adsorbent material within the reactor at the third station 50 may include a different functional group in order to remove heavy metal contaminants different than that targeted by the second station 14. In particular, while thiol-SAMMS may work well on mercury and may have some adsorptive capacity for, for instance, one form of arsenic, a cupric or copper-based SAMMS may have a substantially greater capacity for all species of arsenic.

As it is common in many areas of the world, produced hydrocarbon streams in these areas can often be contaminated with both mercury and arsenic. Accordingly, in accordance with one embodiment of the present invention, the adsorbent material in the reactor of the third station 50 may be functionalized to remove arsenic from the fluid being processed. In particular, the SAMMS material may be functionalized with copper-EDA (i.e., copper-EDA SAMMS) or with lanthanum groups (i.e., lanthanum SAMMS) so that arsenic can be effectively be removed from the fluid flow subsequent to the removal of, for instance, mercury at the second station 14.

Again, although the adsorbent material is disclosed above as being manufactured from SAMMS, it should be appreciated that other adsorbent materials may be used, so long as these adsorbent materials can act to remove contaminants from the fluid flow. One example of an alternate adsorbent material includes commercially carbon particles ranging from about 8 to about 30 mesh in size.

Moreover, although illustrated as being downstream of the second station 14, to the extent desired, the third station 50 may be located upstream of the second station 14, so that arsenic may initially be removed prior to the removal, for instance, mercury. Furthermore, should there be a need to remove other heavy metal contaminants from the fluid being processed, additional stations with reactors having particularly functionalized adsorbent materials to remove targeted heavy metal contaminants can be provided. Such additional stations can be placed, in an embodiment, in series, within system 10. Of course, these additional stations can be placed in parallel, in a combination of series and parallel, or in any configuration upstream of the second station 14, and the treated fluid from these additional stations can subsequently be fed into the second station 14. In addition, it should be appreciated that the provision of the third station 50 or the additional stations for removal of other heavy metal contaminants may be implemented with or without the presence of a prefilter station, such as that illustrated in FIG. 4, in system 10.

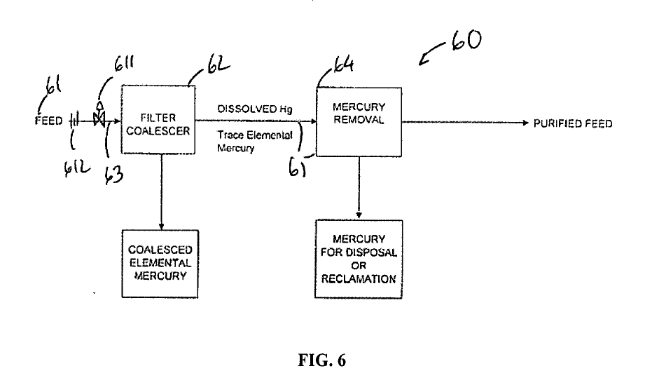

In FIG. 6, there is illustrated another system 60 of the present invention for treating contaminated fluid. Similar to system 10, fluids which may be treated in connection in system 60 may be viscous in nature, such as oil, or non-viscous in nature, such as a liquid or a gas. Moreover, like system 10, contaminants that may be removed by system 60 of the present invention include heavy metals, such as mercury, arsenic, cadmium, and lead from complex waste fluids, such as produced water, and mercury from a variety of waste solutions and contaminated waste oils. Other contaminants that may be removed by system 10 of the present invention includes silver, uranium, plutonium, neptunium, americium, or a combination thereof.

System 60, as illustrated in FIG. 6, includes, in an embodiment, a source 61 from which a flow of contaminated fluid may be introduced into the system. The contaminated fluid may contain various species or forms of heavy metal contaminants, including their elemental form, organic form, and ionic form. The contaminated fluid may be introduced into system 60 at a controlled rate. To control the flow rate of the fluid, a flow control valve 611 may be provided downstream of source 61. In addition, a flow-meter 612 may be provided between the source 61 and the control valve 611 to help in determining the flow rate, and if necessary, to permit adjustment of the control valve 611 to an appropriate level. Although system 10 is shown having a control valve 111, such a valve may not be necessary should the flow rate be adjustable from the source 61.

The system 60 may also include a first station 62 designed to implement a physical separation protocol for removal of elemental species of a targeted heavy metal contaminant, such as mercury, from the fluid flow. In an embodiment, first station 62 may be in fluid communication with source 61 via pathway 63, for example, a pipe, a hose, or any similar conduit capable of conducting fluid flow from source 61 to first station 62. The first station 62, in addition, may include a coalescing unit, substantially similar to coalescing unit 20 shown in FIG. 2, and within which at least one coalescing element, substantially similar to coalescing element 21 shown in FIG. 2, may be situated. Like coalescing element 21, the coalescing element of first station 62 may be designed to coalesce or merge small diameter droplets containing elemental species of the heavy metal contaminant into larger droplets for subsequent removal from the fluid flow.

The system 60 may further include a second station 64 located downstream of the first station 62 and in fluid communication therewith via pathway 65. The second station 64, similar to second station 14 in system 10, may be provided for adsorptive separation or removal of the remainder of the elemental species, now in trace amount, along with the other species of the targeted heavy metal contaminant, such as mercury, from the fluid flow.

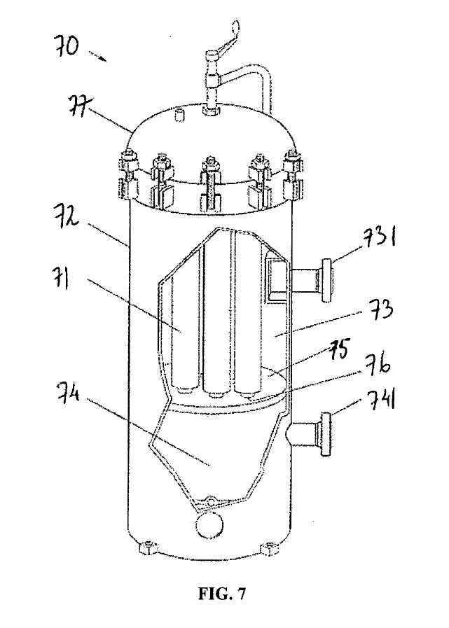

With reference now to FIG. 7, the second station 64, may include a vessel 70 within which at least one filter element 71 may be located for further treatment of fluid from the first station 62 by way of adsorptive separation for removal of various species of the targeted heavy metal contaminant.

The vessel 70, in accordance with one embodiment of the present invention, includes a housing 72 within which the filter element 71 may be accommodated. Housing 72, as illustrated, includes an inlet chamber 73 and an outlet chamber 74 separated by a support plate 75. Support plate 75, in an embodiment, may be designed to include at least one passageway 76 to which the filter element 71 may engage. Of course, a plurality of passageways 76 may be provided into which a complementary number of filter elements 71 may be securely placed. If desired, a plug or cover may be provided for those passageways 76 not in engagement with an apparatus 10. To facilitate placement of the filter element 71 in secured engagement with the passageway 76 along a desired orientation within the inlet chamber 73, and/or removal of filter element 71 therefrom, the vessel 70 may be provided with a sealable closure 77. Such a vessel can be commercially obtained through Perry Equipment Corporation in Mineral Wells, Tex.

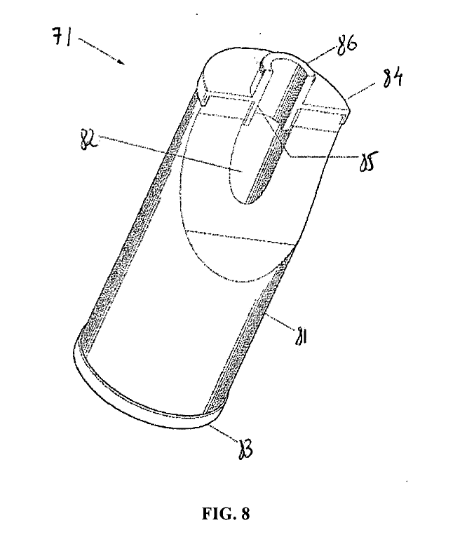

The filter element 71, as shown in FIG. 8 in more detail, may include a substantially tubular body portion 81 and may be made from a fluid permeable material. The filter element 71 may also include a pathway 82 extending between its ends, and along which treated fluid may be directed out of the element 71 in a direction substantially transverse to the flow of fluid into the filter element 71.

In one embodiment, filter element 71 may have incorporated within the body portion 81 an adsorbent material for use in the removal of various species of the targeted heavy metal contaminants, similar to those disclosed above. The adsorbent material, like that used in connection with system 10, may be a nanosorbent material manufactured from self-assembled monolayers on mesoporous supports (SAMMS). The mesoporous support, in an embodiment, may be made from various porous materials, including silica. The advantage of the SAMMS material is its ability to remove all species of various targeted heavy metals, depending on the particular functional group associated with the SAMMS material. An example of a SAMMS material that can be used in connection with the filter element 71 of the present invention includes thiol-SAMMS for targeting all species of mercury, similar to that disclosed in U.S. Pat. No. 6,326,326, which patent is hereby incorporated herein by reference. The SAMMS material, of course, may be functionalized with other groups, depending on the contaminant targeted for removal from the fluid. For instance, the SAMMS material may be functionalized with lanthanum groups for arsenic removal, or with amine groups for CO₂ removal.

In accordance with one embodiment of the present invention, the adsorbent material may include porous particles, ranging from about 5 microns to about 200 microns in size. In one embodiment, the particles, on average, range from about 50 microns to about 80 microns in size, include a pore size ranging from about 2 nanometers (nm) to about 7 nm, and may be provided with an apparent density ranging from about 0.2 grams/milliliter to about 0.4 grams/milliliter.

As noted above, although the adsorbent material is disclosed as being manufactured from SAMMS, it should be appreciated that other adsorbent materials may be used, so long as these adsorbent materials can act to remove contaminants from the fluid flow. One example of an alternate adsorbent material includes commercially carbon particles ranging from about 8 to about 30 mesh in size.

Filter element 71 may further include an upper end cap 83. In one embodiment, the upper cap 83 may be a substantially solid cap, so as to prevent fluid within pathway 82 from flowing through a top end of the element 71. An opposing lower end cap 84 may similarly be provided on filter element 71. The lower cap 84, however, may include an aperture 85 in axial alignment with the pathway 82 to permit treated fluid to exit the filter element 71. Lower cap 84, in an embodiment, may be fitted with an engagement mechanism 86 extending from aperture 85. Engagement mechanism 86 can permit filter element 71 to securely engage a substantially complementary passageway 76 within vessel 70, so that contaminated fluid may be directed across the filter element 71 and into pathway 82.

The upper end cap 83 and lower end cap 84, in an embodiment, may be manufactured from a rigid material. Examples of such a rigid material includes, metals, plastics, or other synthetic material, such as polyester, polypropylene or nylon.

In operation, filter element 71 may be placed within the inlet chamber 73 of vessel 70, and into which fluid containing the remaining heavy metal contaminants from the first station 62 may be directed. After filter element 71 has been placed in secured engagement with passageway 76 along a desired orientation (i.e., the pathway 82 of filter element 71 being in substantial alignment with passageway 76), and the closure 77 of vessel 70 are sealed, contaminated fluid may be directed into the inlet chamber 73 through inlet 731. Once within the inlet chamber 73, contaminated fluid may immerse filter element 71 and be directed to flow substantially radially through the filter element 71. In other words, the contaminated fluid may flow into and across the filter element 71 in a direction substantially transverse, and more particularly substantially perpendicularly, to the pathway 82. As the contaminated fluid flows across the filter element 71, it comes into contact with the adsorbent material, for instance SAMMS material, and can be permitted to flow through the pores of the particles in the SAMMS material. Within these pores, targeted contaminants, such as heavy metals (e.g., mercury) come in contact with a monolayer of chemical designed to attract and bind the molecules of these contaminants, along with the other constituents of the fluid flow. As such, these targeted contaminants may be trapped within the SAMMS and removed from the fluid flow.

The resulting treated fluid may next flow into the pathway 82 of element 71. Once in the pathway 82, the fluid flow changes direction and now moves in a direction substantially parallel to that of the pathway 82 (i.e., substantially transverse to the radial flow of the fluid across the element 71). As it moves along pathway 82, the treated fluid gets directed through aperture 85 of lower end cap 84, across passageway 76, and into outlet chamber 74 of vessel 70, where the fluid can subsequently be directed out of the housing 72 through outlet 741.

It should be appreciated that the present invention also contemplates the filter element 71 being used with a vessel where contaminated fluid may flow from within the filter element 71 outward. In other words, contaminated fluid may be introduced initially through the aperture 85, up into the pathway 82, and directed radially outward across and through the filter element 71.

Once the adsorbent material within the filter element 71 becomes used up or spent, the vessel 70 may be taken out of service, the filter element 71 removed, and a new filter element 71 put in its place. To determine when the adsorbent material may be used up, several approaches may be implemented. In one approach, it is known that as the filter element 71 becomes filled with contaminants, its differential pressure will increase. This is because heavy metal contaminants in the fluid once trapped by the adsorbent material will tend to plug the porous adsorbent material over time. As such, it will be important to monitor the differential pressure of the filter element 71.

In another approach, the status of the adsorbent material may be determined by periodically or continuously monitoring the level of contaminants of the treated fluid in the outlet stream. When the level in the outlet stream increases to a certain point, the filter element 71 may be changed.

Although shown in a vertical position, it should be appreciated that the vessel 70 may be designed to be in a horizontal position with fluid flow direction adapted to the change accordingly. Moreover, the vessel 70, as noted above, may be manufactured to accommodate a plurality of filter elements 71. In such an embodiment, each filter element 71 may be designed to have a rated or allowable flow rate therethrough. In particular, the number of filter element 71 used may be determined, for instance, by taking a total flow rate to be treated and dividing that by an allowable flow rate for one filter element 71. The size of the vessel 70 may then be the size required to place this number of filter elements 71 in close proximity in housing 72.

It should be appreciated that filter element 71 may be any of the filter elements capable of incorporating an adsorbent material therein. Examples of such filter elements include those similarly disclosed in U.S. application Ser. Nos. 11/607,364, 11/731,230, and 11/731,556, all of which are hereby incorporated herein by reference.

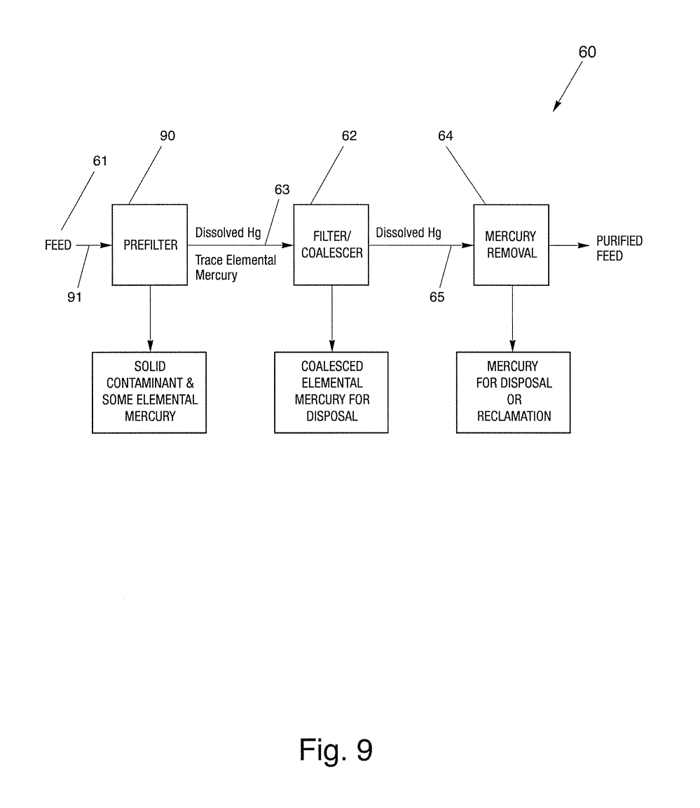

Moreover, although the primary purpose of the adsorbent material is to adsorb a targeted heavy metal contaminants, due to its small size (i.e., from about 5 microns to about 150 microns), the adsorbent material may also be a very good solids filter. This ability to filter solids can result in the adsorbent material be spent or plugged sooner than otherwise necessary. In order to minimize the need to replace these expensive filter elements, system 60, referring now to FIG. 9, may be provided with prefilter station 90 upstream of the first station 62 similar to prefilter station 40 in system 10. The utilization of a prefilter station 90 can also prolong the life, as well as the performance of the more expensive coalescing element at first station 62.

The prefilter station 90, in one embodiment, may include a prefilter reactor similar to that shown in FIG. 4B. Such a reactor may include an inlet through which a continuous flow of contaminated fluid from source 61 may be directed into the prefilter reactor via pathway 91, and an outlet through which treated fluid may exit and gets directed toward the first station 62 via pathway 63. Such a reactor may further include at least one filter element similar to that shown in FIG. 4B designed to remove solid contaminants from the fluid flow.

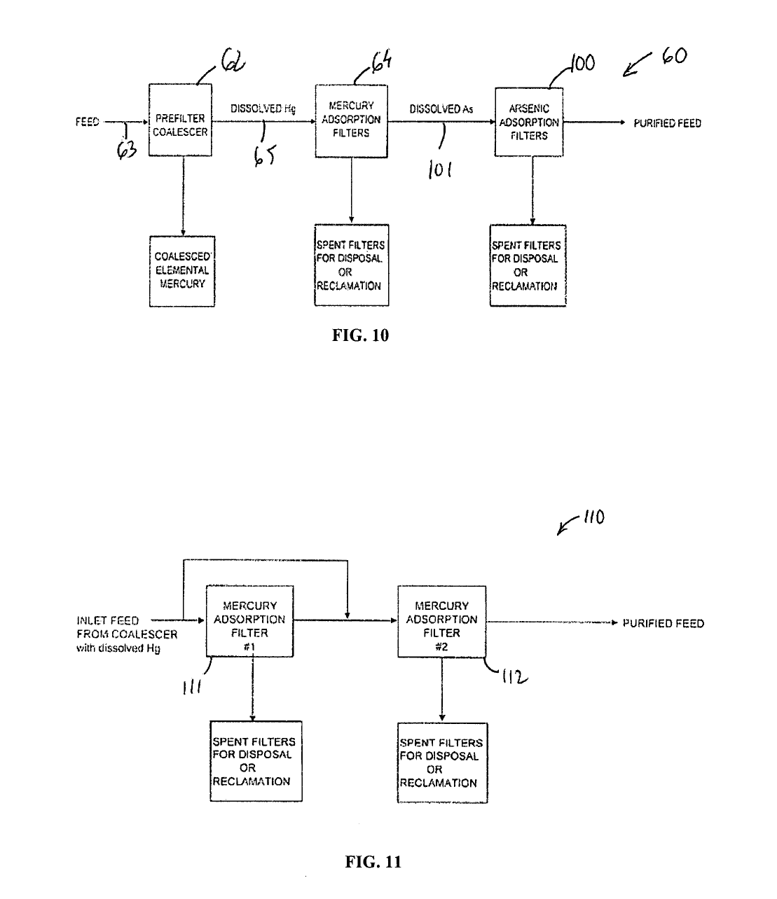

Looking now at FIG. 10, system 60, in accordance with one embodiment of the present invention, may be provided with a third station 100, downstream of the second station 64, for removal of other heavy metal contaminants within the fluid flow directed from the second station 64 through pathway 101. In one embodiment of the present invention, the third station 100 may include a vessel (not shown) substantially similar to vessel 70 of the second station 64, and at least one filter element (not shown) substantially similar to filter element 71 at the second station. Such a filter element may include an adsorbent material therein for the treatment of fluid received from the second station 64 by way of adsorptive separation. The adsorbent material, in one embodiment, may also be a nanosorbent material manufactured from self-assembled monolayers on mesoporous supports (SAMMS). However, it should be appreciated that the adsorbent material may include a different functional group in order to remove heavy metal contaminants different than that targeted by the second station 64. In particular, while thiol-SAMMS may work well on mercury and may have some adsorptive capacity for, for instance, one form of arsenic, a cupric or copper-based SAMMS (i.e., copper-EDA SAMMS) may have a substantially greater capacity for all species of arsenic.

Again, although the adsorbent material is disclosed above as being manufactured from SAMMS, it should be appreciated that other adsorbent materials may be used, so long as these adsorbent materials can act to remove contaminants from the fluid flow. One example of an alternate adsorbent material includes commercially carbon particles ranging from about 8 to about 30 mesh in size.

Although illustrated as being downstream of the second station 64, to the extent desired, the third station 100 may be located upstream of the second station 64, so that, for example, arsenic may initially be removed prior to the removal of, for instance, mercury. Moreover, should there be a need to remove other heavy metal contaminants from the fluid being processed, additional stations with vessels having particularly functionalized adsorbent materials to remove specifically targeted heavy metal contaminants can be provided. Such additional stations can be placed, in an embodiment, in series, within system 60. Of course, these additional stations can be placed in parallel, in a combination of series and parallel, or in any configuration upstream of the second station 64, and the treated fluid from these additional stations can subsequently be fed into the second station 64. Furthermore, it should be appreciated that the provision of the third station 100 or these additional stations for removal of other heavy metal contaminants may be implemented with or without the presence of a prefilter station 90, such as that illustrated in FIG. 9, in system 60.

In yet another embodiment of the present invention, system 10 or system 60 of the present invention may have its third station target the same heavy metal contaminant being targeted in its second station. As illustrated in FIG. 11, system 110 may include a plurality stations 111, 112, in series, designed for adsorptive separation of the same targeted heavy metal contaminant. By providing multiple stations 111 and 112 that can target the same heavy metal contaminant, system 110 can employ continuous processing to enhance its flow capacity (i.e., kinetics) and loading capacity.

Description of system 110 hereinafter will be directed to an embodiment using the vessel and filter elements similar to that in system 60 above. However, it should be appreciated that system 110 can be designed to utilize the reactor and adsorbent material similar to that used in system 10.

With respect to flow capacity, since it may be necessary to allow the fluid to have a certain amount of contact time with the adsorbent material, if only one station 111 targeting a particular heavy metal contaminant is used, the flow may need to be sufficiently slow through that one station in order permit sufficient contact time with the adsorbent material. However, if multiple stations 111 and 112 arranged in series are used for targeting the same heavy metal contaminants, the flow rate and volume can increase significantly, for instance, double or triple, while still permitting the fluid to have sufficient contact time with the adsorbent material. To that end, the size of reactor or vessel at each of stations can be reduced. Moreover, as it may often be the case, a plurality of relatively smaller vessels or reactors can be less expensive than one relatively large vessel or reactor.

In addition to flow capacity, loading capacity can be enhanced. It is well known that adsorbent materials, in general, have a contaminant loading capacity (i.e., equilibrium point) that is a function of the concentration of the targeted contaminant in the fluid. To that end, as contaminated fluid flows across a volume of an adsorbent material, an isotherm may be generated as the targeted contaminant is adsorbed. In particular, the adsorbent material closest to the inlet of the reactor or vessel reaches equilibrium with the concentration of contaminant in the fluid at or near the inlet. Then depending upon the kinetics of the reaction and the flow rate, the concentration of contaminant in the fluid reaches a relatively low level within the remainder of the volume of the adsorbent material. To the extent that there is a set or permissible contaminant level for fluid exiting the outlet (such a level must obviously be lower than the concentration at the inlet), a single station 111 may be employed until the adsorbent material at or near the outlet of the reactor or vessel reaches equilibrium with the set or permissible concentration of contaminant in the fluid permitted to exit the outlet. When such a point is reached, the adsorbent material in this station 111 must be changed as it likely can no longer sufficiently adsorb contaminants so as to lower the amount of contaminants to a concentration level that is permissible to exit the outlet. However, by putting in a second station 112 in series with the first station 111, the adsorbent material within the first station 111 may not need to be changed until the adsorbent material at or near the outlet of the first station 111 reaches equilibrium with the concentration of contaminant in the fluid at or near the inlet. In other words, the adsorbent material in the first station 111 need not be changed until the total volume or amount of the adsorbent material within the first station 111 is spent having the maximum concentration of the targeted contaminant on every particle of the adsorbent material. This is because even if the adsorbent material in the first station 111 can no longer adsorb the targeted contaminant, the adsorbent material in the second station 112 can act to adsorb the same targeted contaminant.

In such a multi-station system, such as that illustrated in FIG. 11, when the adsorbent material in the filter element is spent, the inlet of the vessel at station 111 may be closed and its outlet may be opened to permit draining of the fluid. The filter element with the spent adsorbent material may thereafter be disposed. Fluid flow into the system 110 at the time when first station 111 is not in use may be redirected toward the second station 112. Once the vessel at the first station 111 has been reloaded with a fresh filter element having fresh adsorbent material, the fluid flow from the second station 112 can be directed toward the first station 112 to reinitiate the continuous processing protocol. The same process can be applied when the adsorbent material in the second station 112 is spent.

In accordance with an embodiment of the present invention, the used or spent adsorbent material may be regenerated. To regenerate the adsorbent material for subsequent use, the adsorbent material may be treated with an acidic fluid to remove the adsorbed contaminant. After this regeneration process, the adsorbent material may be put back in service to again remove the contaminants. Regeneration of the adsorbent material, of course, can be implemented for the adsorbent material in system 10 and system 60 described above.

In the embodiment where a reactor and adsorbent material similar to system 10 are used, to collect the adsorbent material for regeneration, a filter (not shown) may be provided near the outlet of the vessel or reactor at each of the stations 111 and 112 to trap the spent adsorbent material. The filter, in an embodiment, may be provided with pores that are substantially smaller than the adsorbent material while still sufficiently large to permit the clean fluid to move therethrough. As the filter becomes full with the spent adsorbent material, the filter may be isolated and removed along with the adsorbent material. A new filter may be put in place for subsequent removal of the adsorbent material.

In an alternate approach, a centrifuge-type separation device (not shown) may be utilized. This device uses centrifugal force to concentrate the spent adsorbent material at the bottom of the device. Once at the bottom of device, the adsorbent material may be removed and directed to a collector, while the cleaned treated fluid may be discharged. The spent adsorbent material may thereafter be disposed or regenerated for subsequent use.

Although only two stations are illustrated and described, it should be noted that system 110 may include three or more stations in series targeting the same heavy metal contaminant.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

1. A system for removal of heavy metal contaminants from fluid, the system comprising:
a pathway along which a flow of fluid containing heavy metal contaminants, along with various species of targeted heavy metal contaminants, can be introduced into the system for removal;
a first station for removal by physical separation of a targeted heavy metal contaminant from the flow of fluid, including elemental species of the targeted heavy metal contaminant, so as to reduce the overall concentration of the targeted heavy metal contaminant from the fluid flow; and
a second station positioned downstream of the first station and in fluid communication therewith for adsorptive separation of the targeted heavy metal contaminant from the fluid flow, including additional amount of the elemental species along with the other species of the targeted heavy metal contaminant, so as to further reduce the concentration of the targeted heavy metal contaminant to an acceptable level.

2. (canceled)

3. A system as set forth in claim 1, wherein the targeted heavy metal contaminant includes one of mercury, arsenic, cadmium, lead, silver, uranium, plutonium, neptunium, americium, other heavy metals, or a combination thereof.

4. (canceled)

5. A system as set forth in claim 1, wherein the contaminated fluid includes one of oils, waste oils, other fluid viscous in nature, or a combination thereof.

6. (canceled)

7. A system as set forth in claim 1, wherein the contaminated fluid includes a liquid, a gas, other fluid non-viscous in nature, or a combination thereof.

8. A system as set forth in claim 7, wherein the non-viscous fluid includes produced water.

9. A system as set forth in claim 1, wherein the first station includes a phase separation device designed to collect droplets containing elemental species of the targeted heavy metal contaminant separated from the fluid flow by gravity.

10. A system as set forth in claim 9, wherein the phase separation device is a liquid/liquid coalescer.

11. A system as set forth in claim 10, wherein the coalescer includes a filter element made from a hydrophilic and oleophilic material to permit the fluid flow to separate the fluid flow into a discontinuous phase and a continuous phase.

12. (canceled)

13. (canceled)

14. A system as set forth in claim 1, wherein the second station includes a slurry mixture of an adsorbent nanomaterial designed to remove various species of the targeted heavy metal contaminants from fluid flow.

15. A system as set forth in claim 14, wherein the adsorbent nanomaterial includes a porous particle made from self-assembled monolayers on mesoporous supports (SAMMS).

16. A system as set forth in claim 15, wherein the SAMMS material is functionalized with thiol.

17. (canceled)

18. A system as set forth in claim 1, wherein the second station includes a filter element having incorporated therein an adsorbent nanomaterial designed to remove various species of the targeted heavy metal contaminants from fluid flow, and a pathway extending the length of the element, along which treated fluid can be directed out from the element.

19. A system as set forth in claim 18, wherein the adsorbent nanomaterial includes a porous particle made from self-assembled monolayers on mesoporous supports (SAMMS).

20. A system as set forth in claim 19, wherein the SAMMS material is functionalized with thiol.

21. (canceled)

22. A system as set forth in claim 1, further including a prefilter station positioned upstream of the first station to remove solid contaminants from the fluid flow.

23. (canceled)

24. A system as set forth in claim 1, further including a third station downstream of the second station and in fluid communication therewith for adsorptive separation of a targeted heavy metal contaminant different from that targeted by the second station.

25. A system as set forth in claim 24, wherein the third station includes a slurry mixture of an adsorbent nanomaterial designed to remove from fluid flow the targeted heavy metal contaminant different from that targeted by the second station.

26. A system as set forth in claim 25, wherein the adsorbent nanomaterial includes a porous particle made from self-assembled monolayers on mesoporous supports (SAMMS).

27. A system as set forth in claim 26, wherein the SAMMS material is functionalized with one of copper-EDA or lanthanum.

28. A system as set forth in claim 24, wherein the third station includes a filter element having incorporated therein an adsorbent nanomaterial designed to remove from fluid flow the targeted heavy metal contaminant different from that targeted by the second station, and a pathway extending the length of the element, along which treated fluid can be directed out from the element.

29. A system as set forth in claim 28, wherein the adsorbent nanomaterial includes a porous particle made from self-assembled monolayers on mesoporous supports (SAMMS).

30. A system as set forth in claim 29, wherein the SAMMS material is functionalized with one of copper-EDA or lanthanum.

31. A system as set forth in claim 1, further including a third station downstream of the second station and in fluid communication therewith for adsorptive separation of the targeted heavy metal contaminant targeted by the second station.

32. A system as set forth in claim 30, wherein the third station is provided with an adsorbent nanomaterial including a porous particle made from self-assembled monolayers on mesoporous supports (SAMMS).

33. A system as set forth in claim 32, wherein the SAMMS material is functionalized with thiol.

34. (canceled)

35. A system for removal of heavy metal contaminants from fluid, the system comprising:
a phase separation device for removal by physical separation of a targeted heavy metal contaminant from a flow of fluid, including elemental species of the targeted heavy metal contaminant, so as to reduce the overall concentration of the targeted heavy metal contaminant from the fluid flow;
an adsorptive separation device positioned downstream of the phase separation device for additional removal of the targeted heavy metal contaminant from the fluid flow, including additional amount of the elemental species along with the other species of the targeted heavy metal contaminant, so as to further reduce the concentration of the targeted heavy metal contaminant to an acceptable level; and
a pathway extending between the phase separation device and the adsorptive separation device to permit fluid communication between the devices.

36. A system as set forth in claim 35, wherein the targeted heavy metal contaminant includes one of mercury, arsenic, cadmium, lead, silver, uranium, plutonium, neptunium, americium, other heavy metals, or a combination thereof.

37. A system as set forth in claim 35, wherein the phase separation device is designed to collect droplets containing elemental species of the targeted heavy metal contaminant separated from the fluid flow by gravity.

38. A system as set forth in claim 35, wherein the phase separation device is a liquid/liquid coalescer.

39. A system as set forth in claim 38, wherein the coalescer includes a filter element made from a hydrophilic and oleophilic material to permit the fluid flow to separate the fluid flow into a discontinuous phase and a continuous phase.

40. A system as set forth in claim 35, wherein the phase separation device includes one of vanes, mesh pads, packed beds, centrifuges, other similar devices, or a combination thereof.

41. A system as set forth in claim 35, wherein the phase separation device, by design, acts to prolong the life and adsorptive separation performance of the adsorptive separation device.

42. A system as set forth in claim 35, wherein the adsorptive separation device includes an amount of adsorbent nanomaterial designed to remove various species of the targeted heavy metal contaminants from fluid flow.

43. A system as set forth in claim 42, wherein the adsorbent nanomaterial includes a porous particle made from self-assembled monolayers on mesoporous supports (SAMMS).

44. A system as set forth in claim 43, wherein the SAMMS material is functionalized with thiol.

45. A system as set forth in claim 35, further including a prefilter station positioned upstream of the phase separation device to remove solid contaminants from the fluid flow.

46. A system as set forth in claim 45, wherein the prefilter station acts to prolong the life and physical separation performance of the phase separation device.

47. A system as set forth in claim 35, further including an additional adsorptive separation device downstream of the first adsorptive separation device for removal of a targeted heavy metal contaminant different from that targeted by the first adsorptive separation device.

48. A system as set forth in claim 47, wherein the additional adsorptive separation device includes an amount of an adsorbent nanomaterial designed to remove from fluid flow the targeted heavy metal contaminant different from that targeted by the first adsorptive separation device.

49. A system as set forth in claim 48, wherein the adsorbent nanomaterial includes a porous particle made from self-assembled monolayers on mesoporous supports (SAMMS).

50. A system as set forth in claim 49, wherein the SAMMS material is functionalized with one of copper-EDA or lanthanum.

51. A system as set forth in claim 47, wherein the additional adsorptive separation device includes an amount of an adsorbent nanomaterial designed to remove from fluid flow a targeted heavy metal contaminant similar to that targeted by the first adsorptive separation device

52. A system as set forth in claim 51, wherein the adsorbent nanomaterial includes a porous particle made from self-assembled monolayers on mesoporous supports (SAMMS).

53. A system as set forth in claim 52, wherein the SAMMS material is functionalized with thiol.

54. A system as set forth in claim 47, wherein the additional adsorptive separation device enhances one of flow capacity, loading capacity, or both to the system.

55. A method for removal of heavy metal contaminants from fluid, the method comprising:
introducing into a pathway a flow of fluid containing heavy metal contaminants to be removed, including various species of targeted heavy metal contaminants;
subjecting the fluid flow to a physical separation protocol for removing a targeted heavy metal contaminant from the fluid, including elemental species of the targeted heavy metal contaminant, so as to reduce the overall concentration of the targeted heavy metal contaminant from the fluid flow; and
exposing the fluid flow having a reduced overall concentration of the targeted heavy metal contaminant to an adsorptive separation protocol for removing additional amount of the targeted heavy metal contaminant from the fluid, including additional amount of the elemental species along with the other species of the targeted heavy metal contaminant, so as to further reduce the concentration of the targeted heavy metal contaminant to an acceptable level.

56. A method as set forth in claim 55, wherein, in the step of introducing, the pathway is in fluid communication with a source of fluid containing the heavy metal contaminants.

57. A method as set forth in claim 55, wherein, in the step of introducing, the targeted heavy metal contaminants includes one of mercury, arsenic, cadmium, lead, silver, uranium, plutonium, neptunium, americium, other heavy metals, or a combination thereof.

58. A method as set forth in claim 55, wherein, in the step of introducing, the contaminated fluid is viscous in nature.

59. A method as set forth in claim 58, wherein, in the step of introducing, the viscous fluid includes one of oils, waste oils, other fluid viscous in nature, or a combination thereof.

60. A method as set forth in claim 55, wherein, in the step of introducing, the contaminated fluid is non-viscous in nature.

61. A method as set forth in claim 60, wherein, in the step of introducing, the non-viscous fluid includes a liquid or a gas.

62. A method as set forth in claim 60, wherein, in the step of introducing, the non-viscous fluid includes produced water.

63. A method as set forth in claim 55, wherein, in the step of subjecting, the physical separation protocol includes phase separation leading to collection of droplets containing elemental species of the targeted heavy metal contaminant separated from the fluid flow by gravity.

64. A method as set forth in claim 55, wherein the step of subjecting includes permitting the fluid flow to separate into a discontinuous phase and a continuous phase.

65. A method as set forth in claim 55, wherein the step of exposing includes employing an adsorbent nanomaterial designed to remove various species of the targeted heavy metal contaminants from fluid flow.

66. A method as set forth in claim 65, wherein, in the step of employing, the adsorbent nanomaterial includes a porous particle made from self-assembled monolayers on mesoporous supports (SAMMS).

67. A method as set forth in claim 66, wherein, in the step of employing, the SAMMS material is functionalized with thiol.

68. A method as set forth in claim 55, further including, prior to the step of subjecting, treating the fluid flow to remove solid contaminants from the fluid flow.

69. A method as set forth in claim 55, further including applying an additional adsorptive separation protocol to the fluid flow for removing a targeted heavy metal contaminant different from that targeted by the initial adsorptive separation protocol.

70. A method as set forth in claim 69, wherein the step of applying includes employing an adsorbent nanomaterial designed to remove from fluid flow a targeted heavy metal contaminant different from that targeted by the initial adsorptive separation protocol.

71. A method as set forth in claim 70, wherein, in the step of applying, the adsorbent nanomaterial includes a porous particle made from self-assembled monolayers on mesoporous supports (SAMMS).

72. A method as set forth in claim 70, wherein, in the step of applying, the SAMMS material is functionalized with one of copper-EDA or lanthanum.

73. A method as set forth in claim 55, further including applying an additional adsorptive separation protocol to the fluid flow for removing a targeted heavy metal contaminant similar to that targeted by the initial adsorptive separation protocol.

74. A method as set forth in claim 73, wherein the step of applying includes employing an adsorbent nanomaterial designed to remove from fluid flow a targeted heavy metal contaminant similar to that targeted by the initial adsorptive separation protocol.

75. A method as set forth in claim 74, wherein, in the step of applying, the adsorbent nanomaterial includes a porous particle made from self-assembled monolayers on mesoporous supports (SAMMS).

76. A method as set forth in claim 75, wherein, in the step of applying, the SAMMS material is functionalized with thiol.

77. A method as set forth in claim 73, wherein the step of applying includes enhancing one of flow capacity, loading capacity, or both.
